(19) United States
(12) Patent Application Publication
(10) Pub. No.: US 2006/0246747 A1
(43) Pub. Date: Nov. 2, 2006

(54) Electronic apparatus with multi-function key

(76) Inventors: Hsin-Hung Li, Kweishan (TW); Wen-Chung Ho, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/390,903

(22) Filed: Mar. 28, 2006

(30) Foreign Application Priority Data
Apr. 29, 2005 (TW) 094113784

(51) Int. Cl. H01R 12/00

(52) U.S. Cl. 439/67

(57) ABSTRACT

An electronic apparatus includes a key, at least one support, and a circuit board. The key has a first press end, a first contact end, a second press end, and a second contact end. The support is mounted onto the key and between the first contact end and the second contact end. The circuit board has a first contact point corresponding to the first contact end and a second contact point corresponding to the second contact end. When the first press end of the key is pressed down, the first contact end goes down together with the first press end to actuate the first contact point of the circuit board, and the support is against a top surface of the circuit board to prevent the second contact end from actuating the second contact point. Accordingly, the key of the electronic apparatus can function well without any error.

### BACKGROUND OF THE INVENTION

1. Field of the Invention

The invention relates to an electronic apparatus, and more particularly to an electronic apparatus with a multi-function key capable of functioning well.

2. Description of the Prior Art

The conventional electronic apparatus, such as mobile phone, personal digital assistant (PDA), remote controller, and so on, is always equipped with several function keys for a user to operate. As science and technology improve and develop, the electronic apparatus usually has various functions, such that a key will has two or more functions for the user to operate.

Referring to FIGS. 1 through 2B, FIG. 1 is an outside view illustrating a PDA 10 of the prior art. FIG. 2A is a part of sectional view along line P-P illustrating the PDA 10 shown in FIG. 1. FIG. 2B is a view illustrating the key 12, which is pressed down, shown in FIG. 2A. As shown in FIGS. 1 and 2A, the PDA 10 includes a key 12 and a circuit board 14. The key 12 has a first press end 120a corresponding to a first contact end 120b thereof and a second press end 122a corresponding to a second contact end 122b thereof. The circuit board 14 has a first contact point 140 corresponding to the first contact end 120b and a second contact point 142 corresponding to the second contact end 122b. When the first press end 120a of the key 12 is pressed down, the first contact end 120b will go down together with the first press end 120a to actuate the first contact point 140 of the circuit board 14. At the same time, the second contact end 122b will also go down together with the key 12 to actuate the second contact point 142 of the circuit board 14, as shown in FIG. 2B. In other words, when a user wants to perform the function corresponding to the first press end 120a of the key 12, the second contact point 142 of the circuit board 14 will be also touched due to inappropriate press force, so as to result in an error. Similarly, when the user wants to perform the function corresponding to the second press end 122a of the key 12, the aforementioned problem similarly happens.

Therefore, the objective of the invention is to provide an electronic apparatus with a multi-function key capable of functioning well to solve the aforementioned problems.

### SUMMARY OF THE INVENTION

An objective of the invention is to provide an electronic apparatus with a multi-function key capable of functioning well to prevent undesired operation due to an inappropriate press force being applied on the key.

The electronic apparatus of the invention includes a key, at least one support, and a circuit board. The key has a first press end corresponding to a first contact end thereof and a second press end corresponding to a second contact end thereof. The at least one support is mounted onto the key and between the first contact end and the second contact end. The circuit board has a top surface, wherein the top surface provides a first contact point corresponding to the first contact end and a second contact point corresponding to the second contact end. When the first press end of the key is pressed down, the first contact end will go down together with the first press end to actuate the first contact point of the circuit board, and then the at least one support will be against the top surface of the circuit board to prevent the second contact end from actuating the second contact point. Similarly, when the second press end of the key is pressed down, the second contact end will go down together with the second press end to actuate the second contact point of the circuit board, and then the at least one support will be against the top surface of the circuit board to prevent the first contact end from actuating the first contact point.

Accordingly, when the user is operating the key of the electronic apparatus, the at least one support can prevent undesired operation due to an inappropriate press force being applied on the key, such that the electronic apparatus with the multi-function key is capable of functioning well.

The advantage and spirit of the invention may be understood by the following recitations together with the appended drawings.

### BRIEF DESCRIPTION OF THE APPENDED DRAWINGS

FIG. 1 is an outside view illustrating a PDA of the prior art.

FIG. 2A is a part of sectional view along line P-P illustrating the PDA shown in FIG. 1.

FIG. 2B is a view illustrating the key, which is pressed down, shown in FIG. 2A.

FIG. 3 is an outside view illustrating an electronic apparatus according to a preferred embodiment of the invention.

FIG. 4 is an outside view illustrating the key shown in FIG. 3.

FIG. 5A is a part of sectional view along line X-X illustrating the electronic apparatus shown in FIG. 3.

FIG. 5B is a view illustrating the key, which is pressed down, shown in FIG. 5A.

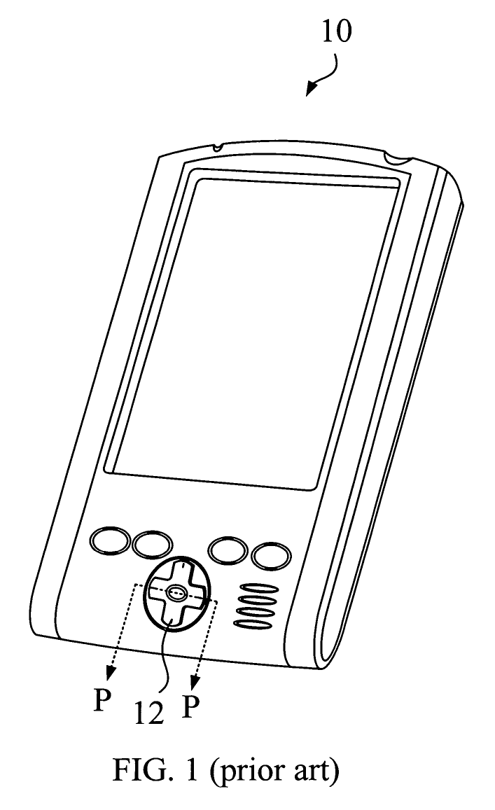

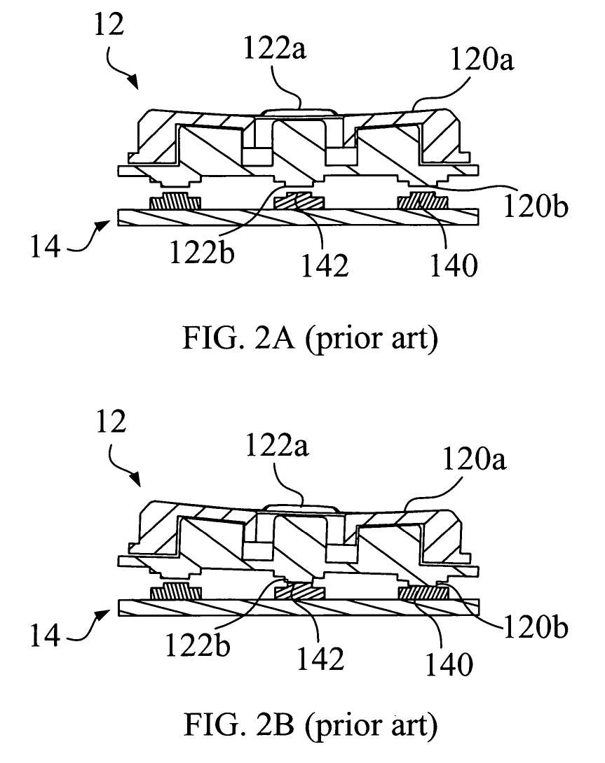

### DETAILED DESCRIPTION OF THE INVENTION

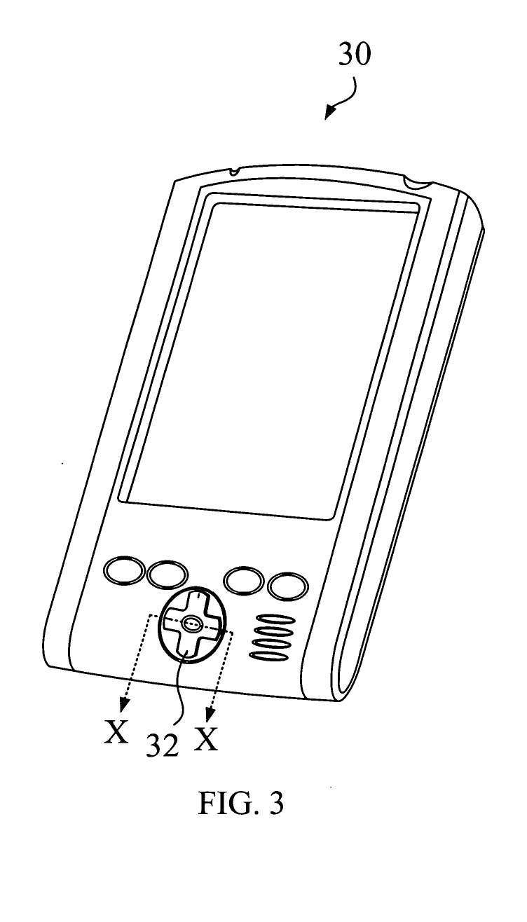

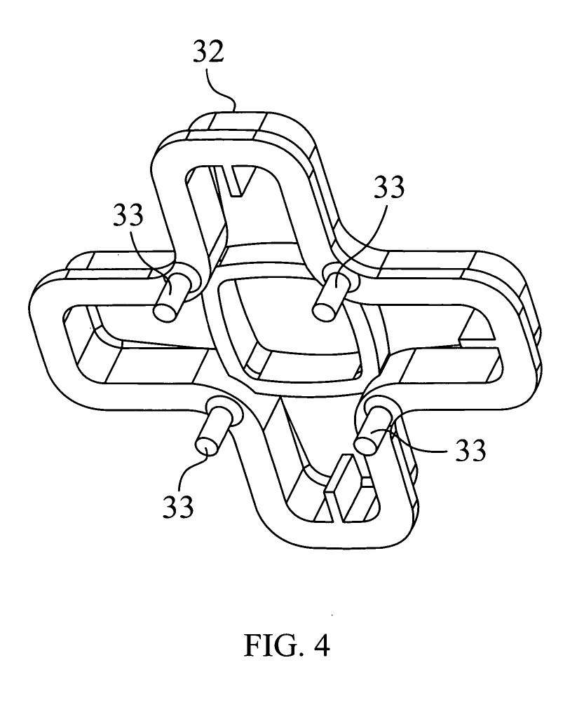

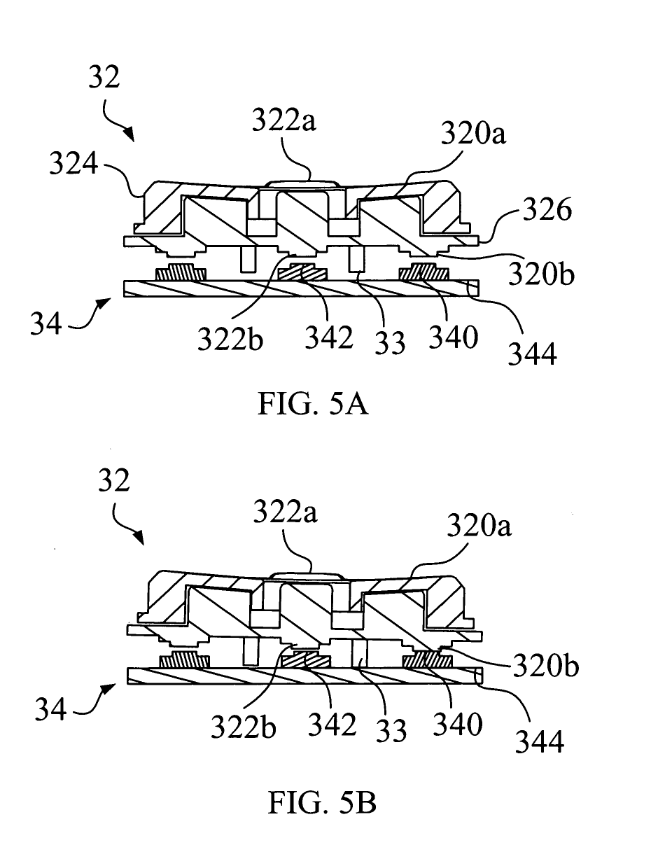

Referring to FIGS. 3 through 5B, FIG. 3 is an outside view illustrating an electronic apparatus 30 according to a preferred embodiment of the invention. FIG. 4 is an outside view illustrating the key 32 shown in FIG. 3. FIG. 5A is a part of sectional view along line X-X illustrating the electronic apparatus 30 shown in FIG. 3. FIG. 5B is a view illustrating the key 32, which is pressed down, shown in FIG. 5A. The electronic apparatus 30 can be a mobile phone, PDA, remote controller, and so on. As shown in FIGS. 3 and 5A, the electronic apparatus 30 comprises a key 32, at least one support 33, and a circuit board 34. In this embodiment, the key 32 further comprises a key cap 324 and a rubber 326, and the electronic apparatus 30 has four supports 33 mounted onto the key 32, as shown in FIG. 4. The shape of the key 32 can be designed as crisscross, disc-shaped, or other shape with multi-function key. In this embodiment, the shape of the key 32 is designed as crisscross.

As shown in FIG. 5A, the key cap 324 provides a first press end 320a and a second press end 322a, and the rubber 326 provides a first contact end 320b and a second contact end 322b. The first press end 320a is corresponding to the first contact end 320b, and the second press end 322a is corresponding to the second contact end 322b. The supports are mounted between the first contact end 320b and the second contact end 322b. The circuit board 34 has a top surface 344, wherein the top surface 344 provides a first contact point 340 corresponding to the first contact end 320b and a second contact point 342 corresponding to the second contact end 322b. The first contact point 340 or the second contact point 342 can be a metal dome, a touch switch, or the like.

As shown in FIG. 5B, when the first press end 320a of the key 32 is pressed down, the first contact end 320b will go down together with the first press end 320a to actuate the first contact point 340 of the circuit board 34, and then the supports 33 will be against the top surface 344 of the circuit board 34 to prevent the second contact end 322b from actuating the second contact point 342. Similarly, when the second press end 322a of the key 32 is pressed down, the second contact end 322b will go down together with the second press end 322a to actuate the second contact point 342 of the circuit board 34, and then the supports 33 will be against the top surface 344 of the circuit board 34 to prevent the first contact end 320b from actuating the first contact point 340. Accordingly, the user can well perform each function of the key 32 without making an error.

Compared to the prior art, when the user is operating the key of the electronic apparatus, the at least one support can either prevent undesired operation due to an inappropriate press force being applied on the key, or avoid undesired chain reaction due to one press end of the key close to another, such that the electronic apparatus with the multi-function key is capable of functioning well.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electronic apparatus, comprising:
a key having a first press end corresponding to a first contact end thereof and a second press end corresponding to a second contact end thereof;
at least one support mounted onto the key and between the first contact end and the second contact end; and
a circuit board having a top surface, wherein the top surface provides a first contact point corresponding to the first contact end and a second contact point corresponding to the second contact end;
wherein when the first press end of the key is pressed down, the first contact end goes down together with the first press end to actuate the first contact point of the circuit board, and the at least one support is against the top surface of the circuit board to prevent the second contact end from actuating the second contact point; and
when the second press end of the key is pressed down, the second contact end goes down together with the second press end to actuate the second contact point of the circuit board, and the at least one support is against the top surface of the circuit board to prevent the first contact end from actuating the first contact point.

2. The electronic apparatus of claim 1, wherein the key comprises:
a key cap providing the first press end and the second press end; and
a rubber providing the first contact end and the second contact end.

3. The electronic apparatus of claim 1, wherein the shape of the key is crisscross.

4. The electronic apparatus of claim 1, wherein the key is disc-shaped.

5. The electronic apparatus of claim 1, wherein the first contact point or the second contact point is a metal dome.

6. The electronic apparatus of claim 1, wherein the first contact point or the second contact point is a touch switch.
